(19) United States
(12) Patent Application Publication
(10) Pub. No.: US 2022/0094108 A1
(43) Pub. Date: Mar. 24, 2022

(54) CONNECTOR

(71) Applicant: MITSUBISHI ELECTRIC CORPORATION, Tokyo (JP)

(72) Inventors: Yosuke WATANABE, Tokyo (JP); Kyota OTSUKA, Tokyo (JP); Kenji HIROSE, Tokyo (JP); Ryota KOBAYASHI, Tokyo (JP); Yuichi SASAKI, Tokyo (JP)

(73) Assignee: MITSUBISHI ELECTRIC CORPORATION, Tokyo (JP)

(21) Appl. No.: 17/539,402

(22) Filed: Dec. 1, 2021

Related U.S. Application Data
(63) Continuation of application No. PCT/JP2019/027887, filed on Jul. 16, 2019.

(51) Int. Cl. H01R 13/6463; H01R 13/6592; H01R 24/86; H01R 4/28

(52) U.S. Cl. CPC H01R 13/6463; H01R 4/28; H01R 24/86; H01R 13/6592

(57) ABSTRACT

A connector includes: a conductive inner shielded cable holding portion having a first bent portion having a shape conforming to the peripheral shape of a first inner shielded cable, and a second bent portion having a shape conforming to the peripheral shape of a second inner shielded cable; and a conductive clamp ring housing having hollow space for allowing the first inner shielded cable and the second inner shielded cable to pass therethrough, and an inner peripheral surface defining the hollow space and having a shape conforming to both the peripheral shape of the first bent portion and the peripheral shape of the second bent portion.

### CROSS REFERENCE TO RELATED APPLICATIONS

This application is a Continuation of PCT International Application No. PCT/JP2019/027887, filed on Jul. 16, 2019, which is hereby expressly incorporated by reference into the present application.

### TECHNICAL FIELD

The present invention relates to a connector which is attached to a double shielded twisted pair cable.

### BACKGROUND ART

There is a differential transmission method, as a signal transmission method suitable for high-speed data communication under an environment with many electromagnetic noises. As for a communication cable used for the differential transmission method, a so-called double shielded twisted pair cable (referred to as a “double STP cable” hereinafter) is known. A double STP cable has multiple twisted pair cables (referred to as “inner shielded cables” hereinafter) each of which is covered with an inner shield conductor, and an outer shield conductor covering all the multiple inner shielded cables. When a double STP cable is connected to one of various types of devices, a connector is attached to an end of the double STP cable, and each of the shield conductors is grounded via the connector. As for a method of connecting an inner shield conductor to the connector at that time, conventionally, a method of soldering one end and the other end of a wire, respectively, to the inner shield conductor and the connector, a method of undoing and stretching a braid forming the inner shield conductor, and making the undone, stretched braid be engaged with the connector, or the like is known.

Here, as for a connector for a coaxial cable having one inner shielded layer and one outer shielded layer, a connector having an intermediate conductor connected to the inner shielded layer through calking and an outer conductor connected to the outer shielded layer through calking is disclosed in, for example, Patent Literature 1.

### CITATION LIST

### Patent Literature

Patent Literature 1: JP 2013-191274 A

### SUMMARY OF INVENTION

### Technical Problem

When a connector is attached to a double STP cable, in each shield conductor's cross section taken along a direction substantially perpendicular to a direction of its axis and having a substantially circular shape (simply referred to as a “cross section” hereinafter), the shielding effect is enhanced as the length of the connection part between the perimeter of the cross section and the connector gets close to the total length of the perimeter of the cross section. However, because any of conventional methods of connecting an inner shield conductor and a connector is one of connecting only a part of a cross section of the inner shield conductor to the connector, a problem with the conventional methods is that a sufficient shielding effect cannot be provided. A connector for coaxial cables each of which has only one inner shielded layer, as described in Patent Literature 1, cannot be used for a double STP cable having multiple inner shield conductors.

The present invention is made in order to solve the above-mentioned problem, and it is therefore an object of the present invention to provide a technology for the connection between a double STP cable and a connector, capable of connecting multiple inner shield conductors to the connector throughout substantially the entire perimeters of their respective cross sections.

### Solution to Problem

According to the present invention, there is provided a connector to be attached to a double shielded twisted pair cable including a first inner shielded cable having a first pair cable and a first inner shield conductor covering the first pair cable, a second inner shielded cable having a second pair cable and a second inner shield conductor covering the second pair cable, and an outer shield conductor covering the first inner shielded cable and the second inner shielded cable, the connector including: a conductive inner shielded cable holding portion having a first bent portion having a shape conforming to the peripheral shape of the first inner shielded cable, and a second bent portion having a shape conforming to the peripheral shape of the second inner shielded cable; and a conductive clamp ring housing having hollow space to allow the first inner shielded cable and the second inner shielded cable to pass through the hollow space, and an inner peripheral surface defining the hollow space and having a shape conforming to both the peripheral shape of the first bent portion and the peripheral shape of the second bent portion.

### Advantageous Effects of Invention

According to the present invention, in the connection between the double STP cable and the connector, the multiple inner shield conductors can be connected to the connector throughout substantially the entire perimeters of their respective cross sections.

### BRIEF DESCRIPTION OF DRAWINGS

FIG. 1 is an outline view showing the structure of a shielded cable to which a connector for shielded cables according to Embodiment 1 is attached;

FIG. 2 is an exploded view showing the structure of the connector for shielded cables according to Embodiment 1;

FIG. 3 is an outline view showing the structure of a connector body portion of the connector for shielded cables according to Embodiment 1;

FIG. 4 is a partial cross-sectional view showing the structure of the connector body portion of the connector for shielded cables according to Embodiment 1;

FIG. 5 is an outline view showing the structure of a sealing nut and the structure of a clamp ring of the connector for shielded cables according to Embodiment 1;

FIG. 6 is an outline view showing the structure of the clamp ring of the connector for shielded cables according to Embodiment 1;

FIG. 7 is a cross-sectional view showing the structure of the clamp ring of the connector for shielded cables according to Embodiment 1;

FIG. 8 is an outline view showing the structure of the sealing nut of the connector for shielded cables according to Embodiment 1;

FIG. 9 is a cross-sectional view showing the structure of the sealing nut of the connector for shielded cables according to Embodiment 1;

FIG. 10 is an outline view showing the structure of an inner shielded cable holding portion of the connector for shielded cables according to Embodiment 1;

FIG. 11 shows a view when the clamp ring shown in FIG. 6 or 7 is viewed from an arrow A;

FIG. 12 shows an outline view showing a state just before the inner shielded cable holding portion is installed in the hollow space of the clamp ring of the connector for shielded cables according to Embodiment 1;

FIG. 13 shows a view showing a state in which the inner shielded cable holding portion is installed in the hollow space of the clamp ring shown in FIG. 11;

FIG. 14 is a view for explaining a method of attaching the connector for shielded cables according to Embodiment 1 to the shielded cable;

FIG. 15 is an enlarged view of the inner shielded cable holding portion to which a first inner shielded cable and a second inner shielded cable are mounted, in the connector for shielded cables according to Embodiment 1; and

FIG. 16 shows a cross-sectional view of the clamp ring in which each of the first and second inner shielded cables is inserted into the hollow space, in the connector for shielded cables according to Embodiment 1.

### DESCRIPTION OF EMBODIMENTS

In recent years, as for a method of implementing high-speed data communications under an environment with many electromagnetic noises, such as in a factory or a vehicle, the adoption of a differential transmission method has been increasing.

The differential transmission method is a method of transmitting a differential signal that includes a normal phase signal and a reverse phase signal which are out of phase with each other and which have an identical amplitude, between a differential driver on a transmit side and a differential receiver on a receive side via two wires that include one pair of conducting wires. This method is suitable for high-speed data transmission, because the voltage amplitude per each of the conducting wires is low and hence the rising time can be shortened.

In typical differential transmission, a twisted pair cable which is formed by twisting two insulated electric wires in each of which a conducting wire is covered with an isolator, and by pairing the two insulated electric wires is used well. Twisted pair cables are widely used, because they are inexpensive and are easy to bend, and their degree of unbalance about earth is higher than those of other pair cables and hence they have a characteristic of not only being resistant to extraneous noises, but also being able to reduce the unnecessary emission of signals.

However, because it is necessary to electrically isolate the inside and the outside of a cable from each other all the more under an environment with many electromagnetic noises, such as in a factory or vehicle, a so-called double shielded twisted pair (referred to as STP hereinafter) cable in which a shield conductor (referred to as an outer shield conductor) is attached to the outside of a twisted pair cable is used.

This STP cable includes, for example, two sets of twisted pair cables that are a bundle of one pair of twisted pair cables via which differential transmission for transmission is performed, and one pair of twisted pair cables via which differential transmission for reception is performed.

More specifically, the STP cable has four core wires in total. Typically, in the STP cable, a structure of covering the whole of the four core wires with a shield is adopted in many cases. Further, in an STP cable which is a bundle of four pairs of twisted pair cables, a structure of covering the whole of eight core wires in total with a shield is adopted in some cases.

However, a problem is that in a case where, for example, multiple twisted pair cables via which different signals like a transmission signal and a reception signal are transmitted are bundled, as mentioned above, the twisted pair cables get close to one another, thereby causing a cross talk to cause the signal waveform to be distorted, so that high-speed signal transmission cannot be performed.

Therefore, in order to aim at a further speedup of differential transmission, a double STP cable having a structure of constructing multiple inner shielded cables by covering each of twisted pair cables with a shield conductor (referred to as an inner shield conductor hereinafter), and further covering a bundle of the multiple inner shielded cables with an outer shield conductor has been developed. The use of this double STP cable makes it possible to not only shield the electrical coupling using the inner shield conductors in such a way that no cross talk occurs between any twisted pair cables, but also achieve electrical isolation from the outside of the double STP cable, using the outer shield conductor.

However, unless each of the inner shield conductors and the outer shield conductor of the double STP cable is grounded, an electric charge induced in each of the shield conductors cannot be dissipated, and the effect as the electrical shield cannot be exerted. Therefore, typically, each of the inner shield conductors and the outer shield conductor of the double STP cable is grounded, in many cases, by connecting each of the shield conductors to a metal housing or the like via a connector.

However, as mentioned above, each of the multiple inner shield conductors is grounded typically, after processing, such as soldering on each of the multiple inner shield conductors or undoing of each braid or each conductor winding for each of the multiple inner shielded conductors. Therefore, there is a possibility that the multiple inner shield conductors are not sufficiently grounded because of a failure in the connection with the connector, the failure occurring on the basis of the processing.

In order to solve the problem as above, a connector for shielded cables according to Embodiment 1 includes an inner shielded cable holding portion for holding inner shielded cables.

Hereinafter, in order to explain the present invention in greater detail, an embodiment of the present invention will be explained with reference to the accompanying drawings.

### Embodiment 1

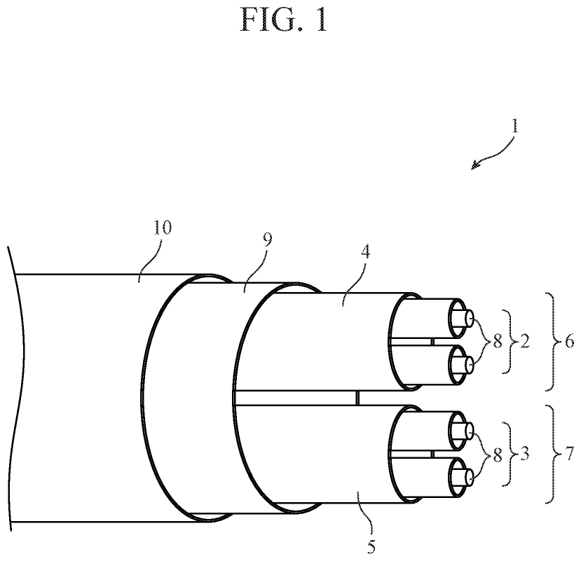

FIG. 1 is an outline view showing the structure of a double STP cable 1 to which a connector 100 according to Embodiment 1 is attached. As shown in FIG. 1, the double STP cable 1 includes a first inner shielded cable 6 having a first pair cable 2 and a first inner shield conductor 4 covering the first pair cable 2, and a second inner shielded cable 7 having a second pair cable 3 and a second inner shield conductor 5 covering the second pair cable 3.

Each cable of the first pair cable 2 and each cable of the second pair cable 3 have core wires 8 at centers inside the respective cables. The double STP cable 1 further includes an outer shield conductor 9 covering the first inner shielded cable 6 and the second inner shielded cable 7. Further, the outer shield conductor 9 is covered with an insulating coating 10.

Each of the first and second pair cables 2 and 3 is a twisted pair cable. However, the double STP cable 1 should just include an outer shield conductor and multiple inner shield conductors, and it is not limited to a double STP cable. Further, the first pair cable 2 and the second pair cable 3 are not limited to twisted pair cables, and each of the pair cables may be a different type of pair cable.

Each of the first inner shield conductor 4, the second inner shield conductor 5, and the outer shield conductor 9 is constructed by, for example, weaving, into a mesh pattern, a shield element wire made of metal having high conductivity such as copper.

By enclosing the first pair cable 2, the first inner shield conductor 4 blocks out an electromagnetic noise flowing from the outside into the first pair cable 2, and also blocks out an electromagnetic noise leaking out from the first pair cable 2.

By enclosing the second pair cable 3, the second inner shield conductor 5 blocks out an electromagnetic noise flowing from the outside into the second pair cable 3, and also blocks out an electromagnetic noise leaking out from the second pair cable 3.

By enclosing the first inner shielded cable 6 and the second inner shielded cable 7, the outer shield conductor 9 blocks out an electromagnetic noise flowing from the outside into each of the first and second inner shielded cables 6 and 7, and also blocks out an electromagnetic noise leaking out from each of the first and second inner shielded cables 6 and 7.

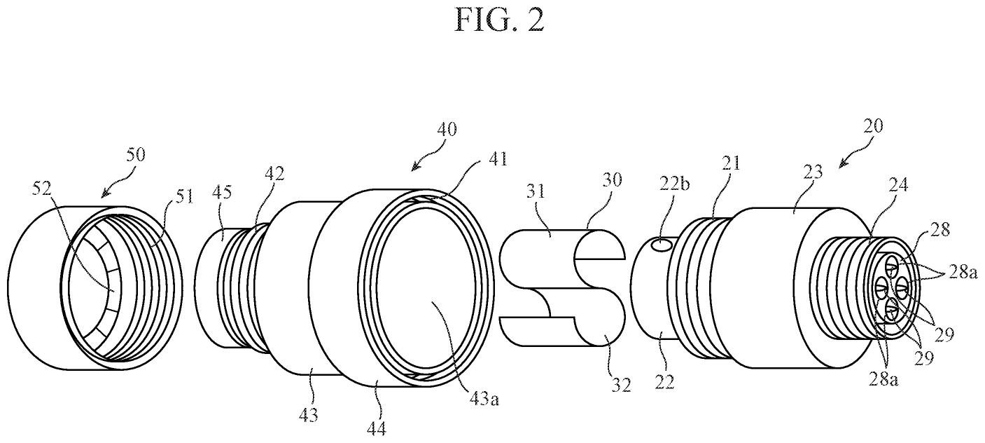

Next, the connector 100 according to Embodiment 1 will be explained by reference to drawings. FIG. 2 is an exploded view showing the structure of the connector 100 according to Embodiment 1. As shown in FIG. 2, the connector 100 includes a connector body portion 20, an inner shielded cable holding portion 30, a clamp ring 40, and a sealing nut 50. The connector body portion 20 has a first male screw portion 21. The clamp ring 40 has a female screw portion 41 fastened to the first male screw portion 21 of the connector body portion 20 at one end thereof, and a male screw portion 42 at the other end thereof. The sealing nut 50 has a female screw portion 51 fastened to the male screw portion 42 of the clamp ring 40. Although mentioned later in detail, the inner shielded cable holding portion 30 is installed inside the clamp ring 40.

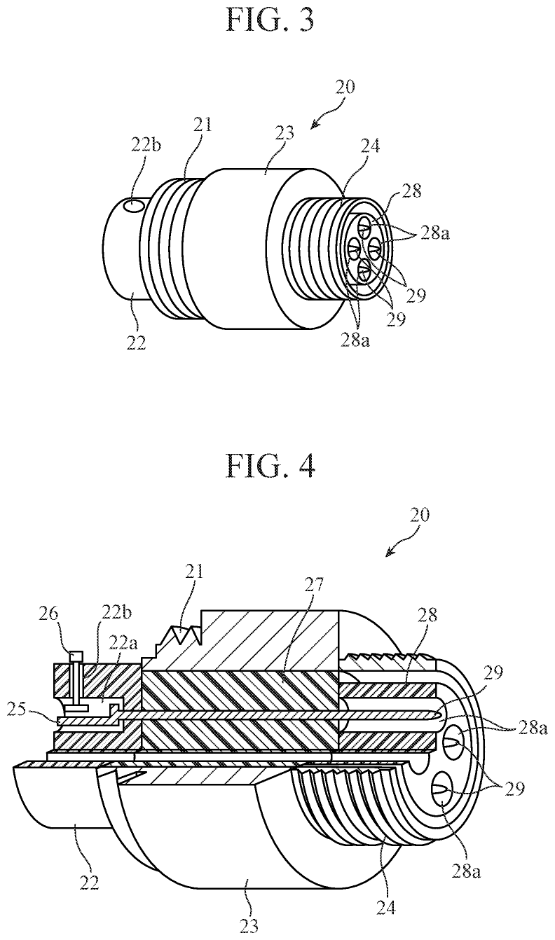

First, the structure of the connector body portion 20 will be explained by reference to drawings. FIG. 3 is an outline view showing the structure of the connector body portion 20. FIG. 4 is a partial cross-sectional view showing the structure of the connector body portion 20. As shown in FIG. 2, 3, or 4, the connector body portion 20 includes a core wire connection portion 22 and a connector housing 23 which are aligned on the same axis. The connector housing 23 has the first male screw portion 21 on an outer peripheral surface of one end thereof on a side of the clamp ring 40, and has a second male screw portion 24 on an outer peripheral surface of the other end thereof. The material of the connector housing 23 is a conductor such as metal, and the one end and the other end are electrically connected to each other.

The core wire connection portion 22 is a component for connecting with the core wires 8 of the first pair cable 2 and the core wires 8 of the second pair cable 3. In further detail, the core wire connection portion 22 has a cylindrical shape, and has core wire plug holes 22a on a bottom face thereof on a side of the clamp ring 40. Core wire receiving conductors 25 are installed inside the core wire plug holes 22a. Further, the core wire connection portion 22 has core wire screw holes 22b formed in a side face thereof and connected to the core wire plug holes 22a. A core wire set screw 26 is installed inside each of the core wire screw holes 22b. The material of the core wire connection portion 22 is, for example, a resin.

Each core wire 8 of either the first pair cable 2 or the second pair cable 3 is inserted into the corresponding core wire plug hole 22a, so that the core wire is in electrical contact with the corresponding core wire receiving conductor 25. In this state, the corresponding core wire set screw 26 is tightened so as to move the core wire 8 toward the core wire receiving conductor 25, so that the core wire 8 is sandwiched and fixed between the core wire set screw 26 and the core wire receiving conductor 25.

A filler 27 and a resin portion 28 are installed in a hollow inside the connector housing 23. The filler 27 is an isolator. Inside the filler 27, connector pins 29 extending from the above-mentioned core wire receiving conductors 25 penetrate. The connector pins 29 are fixed with the filler 27 in such a way as not to be in contact with the connector housing 23. As a result, the connector housing 23 and the connector pins 29 are electrically insulated from each other.

The resin portion 28 has four penetrating holes 28a, and a leading end of the corresponding connector pin 29 penetrating the filler 27 is inserted into each of the penetrating holes 28a. The second male screw portion 24 of the connector housing 23 is fastened to a female screw portion of not-illustrated electronic equipment, so that the second male screw portion is electrically connected to a housing of the electronic equipment. For example, the housing of the electronic equipment is grounded, and, as a result, the connector housing 23 is electrically grounded via the housing of the electronic equipment. Further, at this time, the connector pins 29 are connected to a connector of the electronic equipment. As a result, each core wire 8 of either the first pair cable 2 or the second pair cable 3 is electrically connected to the connector of the electronic equipment via the corresponding connector pin 29 and the corresponding core wire receiving conductor 25.

Although the connector body portion 20 according to Embodiment 1 includes the four core wire plug holes 22a, the four core wire receiving conductors 25, the four core wire screw holes 22b and the four core wire set screws 26 of the core wire connection portion 22, the four penetrating holes 28a, and the four connector pins 29 of the resin portion 28, the number of members included in each type of these components is not limited to four. The connector body portion 20 can include, for each type of the components, members whose number corresponds to the number of core wires included in the pair cables in the shielded cable to be attached.

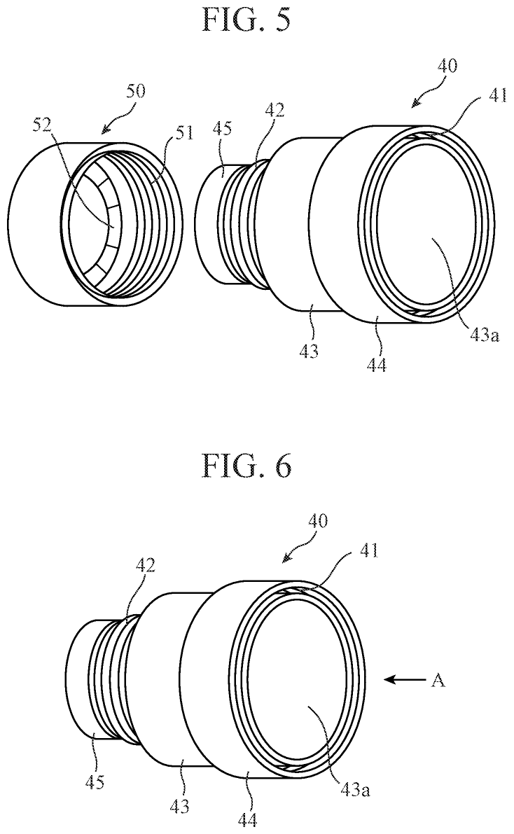

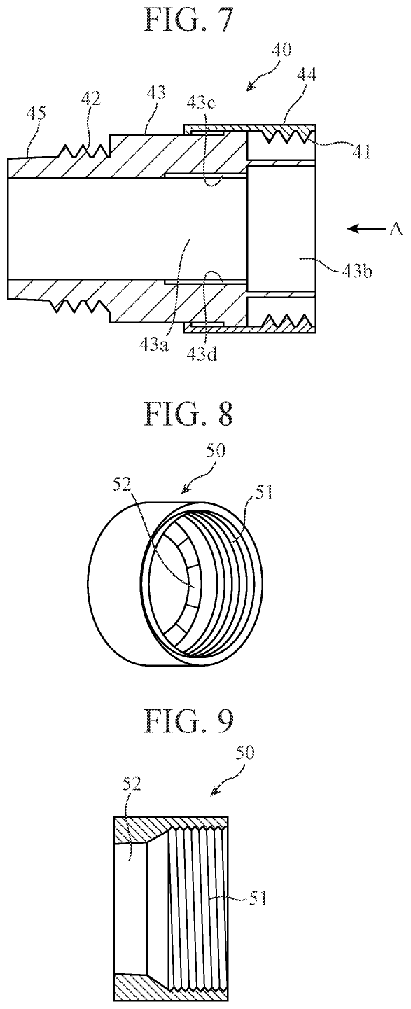

Next, the structure of the sealing nut 50 and the structure of the clamp ring 40 will be explained by reference to drawings. FIG. 5 is an outline view showing the structure of the sealing nut 50 and the structure of the clamp ring 40. FIG. 6 is an outline view showing the structure of the clamp ring 40. FIG. 7 is a cross-sectional view showing the structure of the clamp ring 40.

First, the structure of the clamp ring 40 will be explained. As shown in FIG. 5, 6, or 7, the clamp ring 40 has a shape in which multiple hollow cylinders having different shapes are joined. The clamp ring 40 has an inner diameter which is made to be larger than the outer diameter of the double STP cable 1 in such a way that the double STP cable 1 passes through the inside of the clamp ring. The clamp ring 40 includes a clamp ring housing 43 and a fastening portion 44 which are aligned on the same axis. An outer peripheral surface of the clamp ring housing 43 is fitted to an inner peripheral surface of the fastening portion 44, and the clamp ring housing 43 supports the fastening portion 44 rotatably. Further, a gap is provided in a portion where the outer peripheral surface of the clamp ring housing 43 is fitted to the inner peripheral surface of the fastening portion 44, and the fastening portion 44 can move along a direction of the axis, by a length corresponding to the gap, with respect to the clamp ring housing 43 fitted to the fastening portion.

The fastening portion 44 has the female screw portion 41 on an inner wall at an end thereof on a side of the connector body portion 20. The connector body portion 20, from the core wire connection portion 22's side thereof, is inserted into the fastening portion 44, and then the fastening portion 44 is moved toward the connector body portion 20 and is rotated, so that the female screw portion 41 of the fastening portion 44 and the first male screw portion 21 of the connector housing 23 can be fastened to each other.

The clamp ring housing 43 has hollow space 43a for allowing the first and second inner shielded cables 6 and 7 to pass therethrough from the other end of the clamp ring on a side of the sealing nut 50 to the one end thereof on a side of the connector body portion 20. Further, in a part of the hollow space 43a on a side of the connector body portion 20, the inner diameter of the clamp ring housing 43 is formed in such a way as to be larger than the outer diameter of the core wire connection portion 22 of the connector body portion 20, so that a connector body storage portion 43b for storing the connector body portion 20 is formed.

Further, on an inner peripheral surface of the clamp ring housing 43, the inner peripheral surface being adjacent to the connector body storage portion 43b, a first groove 43c and a second groove 43d for allowing the inner shielded cable holding portion 30 to be installed therein are formed. The structure of the inner shielded cable holding portion 30 will be mentioned later.

Further, on an outer peripheral surface of the clamp ring housing 43 at the end thereof on a side of the sealing nut 50, an outer shield conductor hook portion 45 for allowing the outer shield conductor 9 remaining after removal from the double STP cable 1 to be hooked thereon in a state where the first inner shielded cable 6 and the second inner shielded cable 7 are passed through the hollow space 43a is formed. In further detail, the outer shield conductor hook portion 45 has a taper shape. The taper shape is formed in such a manner that the outer circumference of the clamp ring housing 43 gradually decreases along a direction toward the sealing nut 50.

Further, in a part of the outer peripheral surface of the clamp ring housing 43, the part being adjacent to the outer shield conductor hook portion 45, the above-mentioned male screw portion 42 is formed.

Next, the structure of the sealing nut 50 will be explained. FIG. 8 is an outline view showing the structure of the sealing nut 50. FIG. 9 is a cross-sectional view showing the structure of the sealing nut 50. As shown in FIG. 5, 8, or 9, the sealing nut 50 has a cylindrical shape. The sealing nut 50 has an inner diameter which is larger than the outer diameter of the double STP cable 1 in such a way that the double STP cable 1 can pass through the inside of the sealing nut. Further, on an inner peripheral surface of the sealing nut 50, the above-mentioned female screw portion 51 is formed.

Further, on a part of the inner peripheral surface of the sealing nut 50, the part being adjacent to the female screw portion 51, an outer shield conductor holding portion 52 is formed which is used for, when the female screw portion 51 of the sealing nut 50 and the male screw portion 42 of the clamp ring 40 are fastened to each other, holding the outer shield conductor 9 hooked on the outer shield conductor hook portion 45 by sandwiching the outer shield conductor between the outer shield conductor holding portion and the outer shield conductor hook portion 45. In further detail, the outer shield conductor holding portion 52 has a taper shape corresponding to the taper shape of the outer shield conductor hook portion 45. The taper shape of the sealing nut 50 is formed in such a manner that the inner circumference of the sealing nut 50 gradually increases along a direction toward the clamp ring 40.

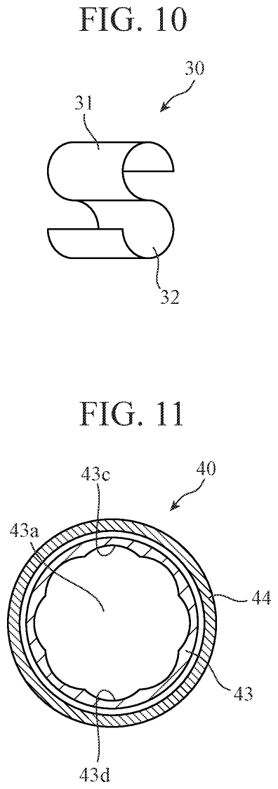

Next, the structure of the inner shielded cable holding portion 30 will be explained by reference to drawings. FIG. 10 is an outline view showing the structure of the inner shielded cable holding portion 30. The inner shielded cable holding portion 30 is a component installed on the inner peripheral surface of the above-mentioned clamp ring housing 43, and used for holding the first inner shielded cable 6 and the second inner shielded cable 7 which are passed through the hollow space 43a.

As shown in FIG. 10, the inner shielded cable holding portion 30 has a first bent portion 31 having a shape conforming to the peripheral shape of the first inner shielded cable 6, and a second bent portion 32 having a shape conforming to the peripheral shape of the second inner shielded cable 7. For example, the first bent portion 31 of the inner shielded cable holding portion 30 is formed by bending an end part of a plate-shaped material toward one surface thereof in such a way that the end part conforms to the peripheral shape of the first inner shielded cable 6. Further, the second bent portion 32 is formed by bending the other end part of the plate-shaped material toward the other surface thereof in such a way that the other end part conforms to the peripheral shape of the second inner shielded cable 7. As a result, the inner shielded cable holding portion 30 has a shape of a letter S. It is preferable that the inner shielded cable holding portion 30 has elasticity in such a manner that the first bent portion 31 is intimate contact with the outer periphery of the first inner shielded cable 6 and the second bent portion 32 is intimate contact with the outer periphery of the second inner shielded cable 7.

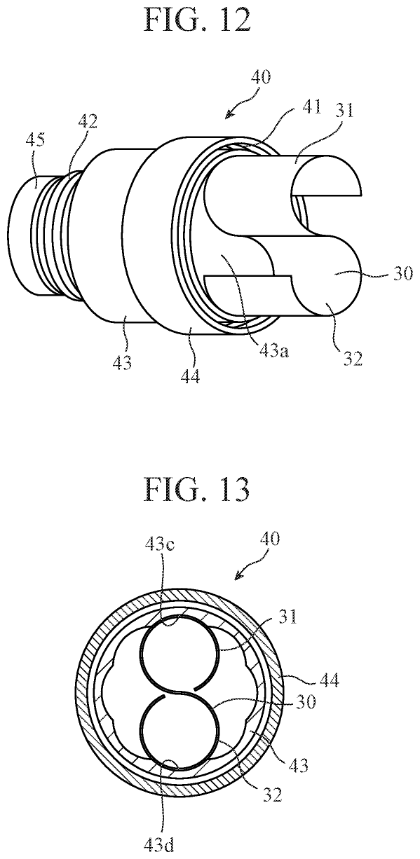

Next, the installation of the inner shielded cable holding portion 30 will be explained in greater detail by reference to drawings. FIG. 11 shows a diagram of the clamp ring 40 shown in above-mentioned FIG. 6 or 7 when the clamp ring is viewed from an arrow A. FIG. 12 shows an outline view showing a state just before the inner shielded cable holding portion 30 is installed in the hollow space 43a of the clamp ring 40. FIG. 13 shows a diagram showing a state where the inner shielded cable holding portion 30 is installed in the hollow space 43a of the clamp ring 40 shown in FIG. 11. In FIGS. 12 and 13, for the sake of explanation, the inner shielded cable holding portion 30 and its surroundings are shown more largely than they actually are.

As shown in FIG. 11, 12, or 13, on the inner peripheral surface of the clamp ring housing 43 of the clamp ring 40, the first groove 43c and the second groove 43d for allowing the inner shielded cable holding portion 30 to be installed therein are formed. On the inner peripheral surface of the clamp ring housing 43 of the clamp ring 40, the first groove 43c is positioned opposite to the second groove 43d.

The first groove 43c has a shape conforming to the peripheral shape of the first bent portion 31 of the inner shielded cable holding portion 30. The second groove 43d has a shape conforming to the peripheral shape of the second bent portion 32 of the inner shielded cable holding portion 30. In further detail, an outer peripheral surface of the first bent portion 31 of the inner shielded cable holding portion 30 is a curved surface, and the first groove 43c has a shape conforming to the shape of the curved surface. An outer peripheral surface of the second bent portion 32 of the inner shielded cable holding portion 30 is a curved surface, and the second groove 43d has a shape conforming to the shape of the curved surface.

The inner shielded cable holding portion 30 is inserted into the clamp ring 40 from an opening of the clamp ring on a side of the connector body portion 20. Then, the outer peripheral surface of the first bent portion 31 of the inner shielded cable holding portion 30 is fitted into the first groove 43c, and the outer peripheral surface of the second bent portion 32 of the inner shielded cable holding portion 30 is fitted into the second groove 43d, so that the inner shielded cable holding portion 30 is installed on the inner peripheral surface of the clamp ring housing 43. As a result, the inner shielded cable holding portion 30 and the clamp ring 40 are electrically connected to each other. Further, because the first groove 43c has a shape conforming to the peripheral shape of the first bent portion 31 and the second groove 43d has a shape conforming to the peripheral shape of the second bent portion 32, the area of the contact between the inner shielded cable holding portion 30 and the clamp ring 40 can be increased relatively.

Further, a groove similar to the first groove 43c is formed in an area adjacent to the first groove 43c, while another groove similar to the first groove 43c is formed in an area opposite to the former groove and adjacent to the second groove 43d. Because the grooves for allowing the inner shielded cable holding portion 30 to be installed therein are thus formed throughout the entire perimeter of the inner peripheral surface of the clamp ring housing 43, the position of the inner shielded cable holding portion 30 can be changed in the hollow space 43a of the clamp ring housing 43 in accordance with the positions of the first inner shielded cable 6 and the second inner shielded cable 7.

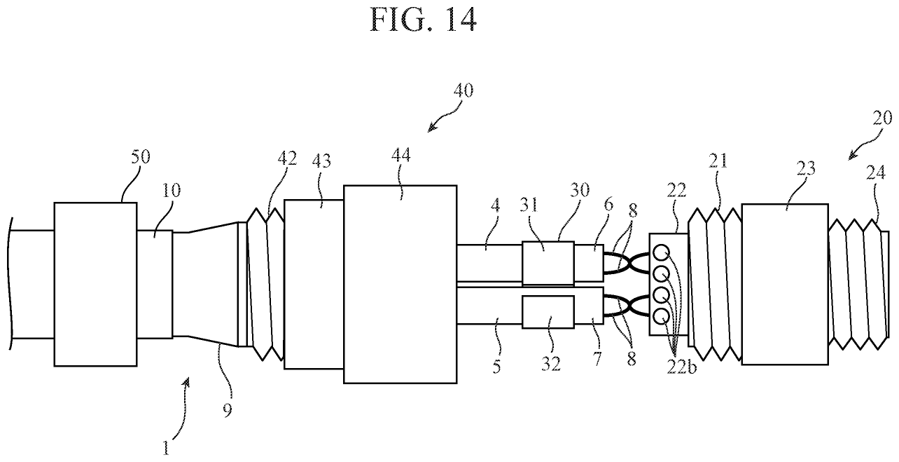

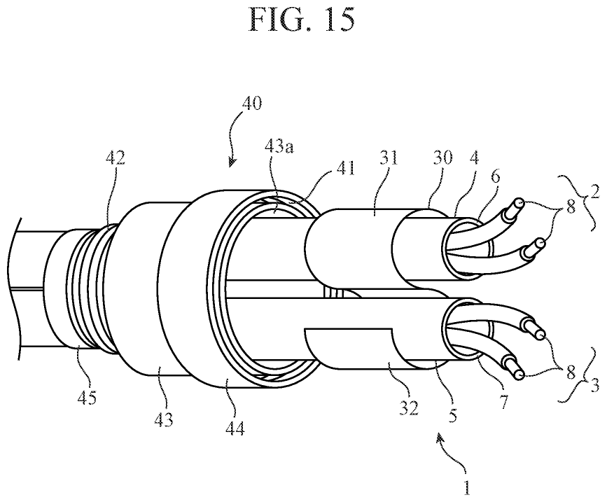

Next, a method of attaching the connector 100 to the double STP cable 1 will be explained by reference to drawings. FIG. 14 is a diagram for explaining the method of attaching the connector 100 to the double STP cable 1. In FIG. 14, for the sake of explanation, a state in which each of the first and second inner shielded cables 6 and 7 is extended from a side of the clamp ring 40 toward a side of the connector body portion 20 is shown. First, a part of the insulating coating 10 of the double STP cable 1 is cut away from an end of the double STP cable 1, the part having the same length as the linear dimension in an axis direction of the connector 100 when the connector body portion 20 and the clamp ring 40 are fastened to each other and the clamp ring 40 and the sealing nut 50 are fastened to each other, so that the part is removed.

Next, apart of the outer shield conductor 9 of the double STP cable 1 from which the insulating coating 10 is removed is cut away from the end of the double STP cable 1, the part having the length from the core wire connection portion 22 of the connector body portion 20 to just before the outer shield conductor hook portion 45 of the clamp ring 40 when the connector body portion 20 and the clamp ring 40 are fastened to each other, so that the part is removed.

Next, the sealing nut 50 is passed through from the end of the double STP cable 1 to the position of the insulating coating 10. Next, the clamp ring 40 is passed through from the end of the double STP cable 1 to the position where the insulating coating 10 remains.

Next, parts of the exposed first inner shield conductor 4 of the first inner shielded cable 6 and the exposed second inner shield conductor 5 of the second inner shielded cable 7 are cut away from respective ends of the inner shielded cables, each of the parts having a length corresponding to that of parts of the core wires 8 to be inserted into the core wire plug holes 22a of the core wire connection portion 22 of the connector body portion 20, so that the parts of the first and second inner shield conductors are removed.

Next, the inner shielded cable holding portion 30 is attached to the end of the first inner shielded cable 6 and the end of the second inner shielded cable 7. FIG. 15 is a diagram showing the inner shielded cable holding portion 30 to which the first inner shielded cable 6 and the second inner shielded cable 7 are attached. In FIG. 15, for the sake of explanation, the first inner shielded cable 6, the second inner shielded cable 7, and the inner shielded cable holding portion 30 are shown more largely than they actually are. As shown in FIG. 15, the first inner shielded cable 6 and the second inner shielded cable 7 are attached to the inner shielded cable holding portion 30 in such a way that the outer peripheral surface of the first inner shielded cable 6 is covered with the first bent portion 31 and the outer peripheral surface of the second inner shielded cable 7 is covered with the second bent portion 32. As a result, the first inner shield conductor 4 and the second inner shield conductor 5, and the inner shielded cable holding portion 30 are electrically connected to each other.

Next, the core wires 8 of either the first pair cable 2 or the second pair cable 3 are inserted into the core wire plug holes 22a of the core wire connection portion 22 of the connector body portion 20, and the core wire set screws 26 inside the core wire screw holes 22b are rotated, so that the core wires are sandwiched and fixed between the core wire set screws 26 and the core wire receiving conductors 25.

Next, the clamp ring 40 is brought back toward the connector body portion 20 to which the core wires 8 are connected, and the fastening portion 44 of the clamp ring 40 is rotated, so that the female screw portion 41 of the fastening portion 44 and the first male screw portion 21 of the connector housing 23 are fastened to each other. As a result, the clamp ring 40 and the connector body portion 20 are fastened to each other.

Next, the outer shield conductor 9 remaining after removal from the double STP cable 1 is hooked on the outer shield conductor hook portion 45 of the clamp ring housing 43. In further detail, the outer shield conductor 9 covers the outer shield conductor hook portion 45 in such a way as to envelop the outer shield conductor hook portion 45 throughout the entire perimeter of the outer shield conductor hook portion 45.

Next, the sealing nut 50 is brought back toward the clamp ring 40 on which the outer shield conductor 9 is hooked, and the sealing nut 50 is rotated, so that the female screw portion 51 of the sealing nut 50 and the male screw portion 42 of the clamp ring 40 are fastened to each other. As a result, the sealing nut 50 and the clamp ring 40 are fastened to each other. Further, the outer shield conductor 9 is sandwiched between the outer shield conductor holding portion 52 of the sealing nut 50 and the outer shield conductor hook portion 45 of the clamp ring housing 43, so that the outer shield conductor is held.

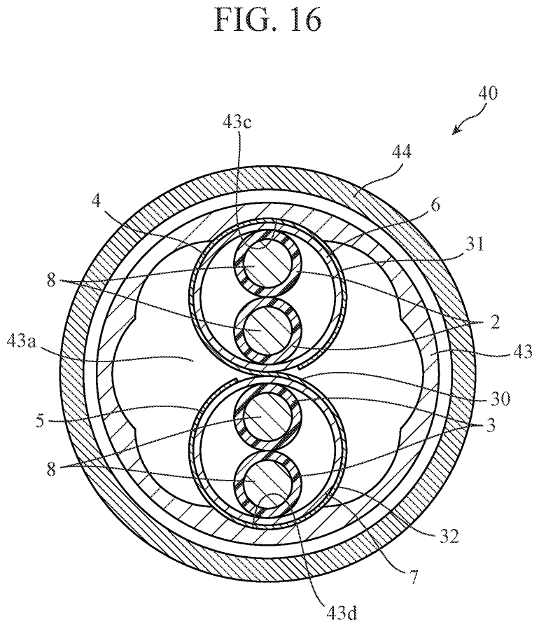

FIG. 16 shows a cross-sectional view of the clamp ring 40 in which each of the first and second inner shielded cables 6 and 7 is inserted into the hollow space 43a. In FIG. 16, for the sake of explanation, the first inner shielded cable 6, the second inner shielded cable 7, and their surroundings are shown more largely than they actually are. As shown in FIG. 16, the inner peripheral surface of the first bent portion 31 of the inner shielded cable holding portion 30 is in contact with the first inner shield conductor 4 throughout substantially the entire perimeter of a cross section of the first inner shielded cable 6. Further, the inner peripheral surface of the second bent portion 32 of the inner shielded cable holding portion 30 is in contact with the second inner shield conductor 5 throughout substantially the entire perimeter of a cross section of the second inner shielded cable 7.

Further, the outer peripheral surface of the first bent portion 31 of the inner shielded cable holding portion 30 is fitted into the first groove 43c, and the outer peripheral surface of the second bent portion 32 of the inner shielded cable holding portion 30 is fitted into the second groove 43d. As a result, each of the first and second inner shield conductors 4 and 5 is electrically connected, via the inner shielded cable holding portion 30, the clamp ring housing 43, the fastening portion 44, and the connector housing 23, to the housing of electronic equipment connected to the second male screw portion 24 of the connector housing 23. As a result, the first inner shield conductor 4 and the second inner shield conductor 5 are grounded.

As mentioned above, the first inner shield conductor 4 and the second inner shield conductor 5 are connected to the connector 100 throughout substantially the entire perimeters of their respective cross sections. Because the shielding effect is enhanced as the length of the connection part between the perimeter of the cross section of each shield conductor and the connector gets close to the total length of the perimeter of the cross section, as mentioned above, it is possible to enhance the electrical shielding effect of the entire system including the double STP cable 1 and the connector 100.

Further, the outer shield conductor 9 held as the result of being sandwiched between the outer shield conductor holding portion 52 and the outer shield conductor hook portion 45 is electrically connected, via the clamp ring housing 43, the fastening portion 44, and the connector housing 23, to the housing of the electronic equipment connected to the second male screw portion 24 of the connector housing 23. As a result, the outer shield conductor holding portion 52 is grounded.

As mentioned above, the outer shield conductor 9 is sandwiched between the outer shield conductor holding portion 52 and the outer shield conductor hook portion 45, so that the outer shield conductor 9 is connected to the connector 100 throughout substantially the entire perimeter of its cross section. Because the shielding effect is enhanced as the length of the connection part between the perimeter of the cross section of the shield conductor and the connector gets close to the total length of the perimeter of the cross section, as mentioned above, it is possible to enhance the electrical shielding effect of the entire system including the double STP cable 1 and the connector 100.

In Embodiment 1, the connector 100 which is attached to the double STP cable 1 including the two inner shielded cables: the first inner shielded cable 6 and the second inner shielded cable 7 is explained. However, the present invention can also be applied to a double STP cable 1 including three or more inner shielded cables. In that case, the connector 100 includes an inner shielded cable holding portion for holding the three or more inner shielded cables passed through the hollow space 43a, on the inner peripheral surface of the clamp ring housing 43. For example, in the case where the number of inner shielded cables is four, the inner shielded cable holding portion further includes a third bent portion and a fourth bent portion. The third bent portion has a shape conforming to the peripheral shape of a third inner shielded cable, and the fourth bent portion has a shape conforming to the peripheral shape of a fourth inner shielded cable. The third bent portion is formed by further bending a part extending from the end of the first bent portion 31 bent toward the one surface toward the other surface in such a way that the part being bent covers the outer periphery of the third inner shielded cable. Further, the fourth bent portion is formed by further bending a part extending from the end of the second bent portion 32 bent toward the other surface toward the one surface in such a way that the part being bent covers the outer periphery of the fourth inner shielded cable.

As an alternative, for example, the connector 100 may include two or more inner shielded cable holding portions 30 as above on the inner peripheral surface of the clamp ring housing 43, in order to hold the three or more inner shielded cables passed through the hollow space 43a. For example, in the case where the number of inner shielded cables is four, in a first inner shielded cable holding portion out of the two inner shielded cable holding portions 30, a first bent portion has a shape conforming to the peripheral shape of a first inner shielded cable, and a second bent portion has a shape conforming to the peripheral shape of a second inner shielded cable. In a second inner shielded cable holding portion, a first bent portion has a shape conforming to the peripheral shape of a third inner shielded cable, and a second bent portion has a shape conforming to the peripheral shape of a fourth inner shielded cable.

As mentioned above, the connector 100 according to Embodiment 1 is attached to a double shielded twisted pair cable 1 including a first inner shielded cable 6 having a first pair cable 2 and a first inner shield conductor 4 covering the first pair cable 2, a second inner shielded cable 7 having a second pair cable 3 and a second inner shield conductor 5 covering the second pair cable 3, and an outer shield conductor 9 covering the first inner shielded cable 6 and the second inner shielded cable 7, and includes: the conductive inner shielded cable holding portion 30 having the first bent portion 31 having a shape conforming to the peripheral shape of the first inner shielded cable 6, and the second bent portion 32 having a shape conforming to the peripheral shape of the second inner shielded cable 7; and the conductive clamp ring housing 43 having the hollow space 43a for allowing the first inner shielded cable 6 and the second inner shielded cable 7 to pass therethrough, and the inner peripheral surface defining the hollow space 43a and having a shape conforming to both the peripheral shape of the first bent portion 31 and the peripheral shape of the second bent portion 32.

According to the above-mentioned structure, on the inner peripheral surface of the clamp ring housing 43, the inner shielded cable holding portion 30 having the first bent portion 31 having a shape conforming to the peripheral shape of the first inner shielded cable 6, and the second bent portion 32 having a shape conforming to the peripheral shape of the second inner shielded cable 7 is installed. As a result, the first inner shield conductor 4 and the second inner shield conductor 5 can be connected to the connector 100 throughout substantially the entire perimeters of their respective cross sections.

Because the shielding effect is enhanced as the length of the connection part between the perimeter of the cross section of each shield conductor and the connector gets close to the total length of the perimeter of the cross section, as mentioned above, it is possible to enhance the electrical shielding effect of the entire system including the double STP cable 1 and the connector 100 when the connector 100 is grounded in such a way that the first inner shield conductor 4 and the second inner shield conductor 5 are grounded.

Further, in the connector 100 according to Embodiment 1, the inner shielded cable holding portion 30 is a plate-shaped component, and the first bent portion 31 is bent toward the one surface of the plate-shaped component in such a way as to conform to the peripheral shape of the first inner shielded cable 6, while the second bent portion 32 is bent toward the other surface of the plate-shaped component in such a way as to conform to the peripheral shape of the second inner shielded cable 7.

According to the above-mentioned structure, the first inner shield conductor 4 and the second inner shield conductor 5 can be connected to the connector 100 throughout substantially the entire perimeters of their respective cross sections, by means of the simple structure. As a result, when the connector 100 is grounded in such a way that the first inner shield conductor 4 and the second inner shield conductor 5 are grounded, it is possible to enhance the electrical shielding effect of the entire system including the double STP cable 1 and the connector 100.

Further, the connector 100 according to Embodiment 1 further includes the connector body portion 20 having the male screw portion 21, the fastening portion 44 having the female screw portion 41 fastened to the male screw portion 21 of the connector body portion 20 is disposed at one end of the clamp ring housing 43, and the connector body portion 20 includes the core wire connection portion 22 for connecting with each core wire 8 of the first pair cable 2 and each core wire 8 of the second pair cable 3.

According to the above-mentioned structure, the first and second inner shielded cables 6 and 7 whose each core wire 8 is connected to the core wire connection portion 22 of the connector body portion 20 are held, in the hollow space 43a of the clamp ring housing 43, by the inner shielded cable holding portion 30. As a result, a signal can be transmitted and received, via each core wire 8, to and from electronic equipment connected to the connector body portion 20 in the state where the first inner shield conductor 4 and the second inner shield conductor 5 are connected to the connector 100 throughout substantially the entire perimeters of their respective cross sections.

The connector 100 according to Embodiment 1 further includes the sealing nut 50 having the female screw portion 51, the clamp ring housing 43 further has, at the other end, the male screw portion 42 fastened to the female screw portion 51 of the sealing nut 50, the outer shield conductor hook portion 45 for allowing the outer shield conductor 9 remaining after removal from the double STP cable 1 to be hooked thereon in the state where the first and second inner shielded cables 6 and 7 are passed through the hollow space 43a is disposed on an outer peripheral surface of the clamp ring housing 43 at the other end, and the outer shield conductor holding portion 52 for holding the outer shield conductor 9 hooked on the outer shield conductor hook portion 45 by sandwiching the outer shield conductor between the outer shield conductor holding portion and the outer shield conductor hook portion 45 when the female screw portion 51 of the sealing nut 50 and the male screw portion 42 of the clamp ring housing 43 are fastened to each other is disposed on the inner peripheral surface of the sealing nut 50.

According to the above-mentioned structure, the outer shield conductor 9 is held as the result of being sandwiched between the outer shield conductor holding portion 52 and the outer shield conductor hook portion 45. As a result, the outer shield conductor 9 can be connected to the connector 100 throughout substantially the entire perimeter of its cross section.

Because the shielding effect is enhanced as the length of the connection part between the perimeter of the cross section of the shield conductor and the connector gets close to the total length of the perimeter of the cross section, as mentioned above, it is possible to enhance the electrical shielding effect of the entire system including the double STP cable 1 and the connector 100 when the connector 100 is grounded in such a way that the outer shield conductor 9 is grounded.

Further, in the connector 100 according to Embodiment 1, the outer shield conductor hook portion has a taper shape, and the outer shield conductor holding portion has a taper shape corresponding to the taper shape of the outer shield conductor hook portion.

According to the above-mentioned structure, the outer shield conductor 9 can be connected to the connector 100 throughout substantially the entire perimeter of its cross section, by means of the simple structure. As a result, when the connector 100 is grounded in such a way that the outer shield conductor 9 is grounded, it is possible to enhance the electrical shielding effect of the entire system including the double STP cable 1 and the connector 100.

It is to be understood that various changes can be made in any component in the embodiment or any component in the embodiment can be omitted within the scope of the present invention.

### INDUSTRIAL APPLICABILITY

Because the connector for shielded cables according to the present invention makes it possible to, in the connection between a double STP cable and the connector, connect multiple inner shield conductors to the connector throughout substantially the entire perimeters of their respective cross sections, the connector can be used as a connector which is attached to a double shielded twisted pair cable.

### REFERENCE SIGNS LIST

1 double STP cable, 2 first pair cable, 3 second pair cable, 4 first inner shield conductor, 5 second inner shield conductor, 6 first inner shielded cable, 7 second inner shielded cable, 8 core wire, 9 outer shield conductor, 10 insulating coating, 20 connector body portion, 21 first male screw portion, 22 core wire connection portion, 22a core wire plug hole, 22b core wire screw hole, 23 connector housing, 24 second male screw portion, 25 core wire receiving conductor, 26 core wire set screw, 27 filler, 28 resin portion, 28a penetrating hole, 29 connector pin, 30 inner shielded cable holding portion, 31 first bent portion, 32 second bent portion, 40 clamp ring, 41 female screw portion, 42 male screw portion, 43 clamp ring housing, 43a hollow space, 43b connector body storage portion, 43c first groove, 43d second groove, 44 fastening portion, 45 outer shield conductor hook portion, 50 sealing nut, 51 female screw portion, 52 outer shield conductor holding portion, and 100 connector.

1. A connector to be attached to a double shielded twisted pair cable including a first inner shielded cable having a first pair cable and a first inner shield conductor covering the first pair cable, a second inner shielded cable having a second pair cable and a second inner shield conductor covering the second pair cable, and an outer shield conductor covering the first inner shielded cable and the second inner shielded cable, the connector comprising:
a conductive inner shielded cable holding portion having a first bent portion having a shape conforming to a peripheral shape of the first inner shielded cable, and a second bent portion having a shape conforming to a peripheral shape of the second inner shielded cable; and
a conductive clamp ring housing having hollow space to allow the first inner shielded cable and the second inner shielded cable to pass through the hollow space, and an inner peripheral surface defining the hollow space and having a shape conforming to both a peripheral shape of the first bent portion and a peripheral shape of the second bent portion.

2. The connector according to claim 1, wherein the inner shielded cable holding portion is a plate-shaped member, the first bent portion is bent toward one surface of the plate-shaped member such a way as to conform to the peripheral shape of the first inner shielded cable, and the second bent portion is bent toward the other surface of the plate-shaped member in such a way as to conform to the peripheral shape of the second inner shielded cable.

3. The connector according to claim 1, further including a connector body portion having a male screw portion,
wherein a fastening portion having a female screw portion fastened to the male screw portion of the connector body portion is disposed at one end of the clamp ring housing, and
the connector body portion includes a core wire connection portion to connect with core wires of the first pair cable and core wires of the second pair cable.

4. The connector according to claim 1, further including a sealing nut having a female screw portion,
wherein the clamp ring housing further has, at the other end, a male screw portion fastened to the female screw portion of the sealing nut,
on an outer peripheral surface of the clamp ring housing at the other end, an outer shield conductor hook portion to allow the outer shield conductor remaining after removal from the double shielded twisted pair cable to be hooked on the outer shield conductor hook portion in a state where the first inner shielded cable and the second inner shielded cable are passed through the hollow space is disposed, and
on an inner peripheral surface of the sealing nut, an outer shield conductor holding portion to hold the outer shield conductor hooked on the outer shield conductor hook portion by sandwiching the outer shield conductor between the outer shield conductor holding portion and the outer shield conductor hook portion when the female screw portion of the sealing nut and the male screw portion of the clamp ring housing are fastened to each other is disposed.

5. The connector according to claim 4, wherein the outer shield conductor hook portion has a taper shape, and
the outer shield conductor holding portion has a taper shape corresponding to the taper shape of the outer shield conductor hook portion.
